(19) United States
(12) Patent Application Publication
(10) Pub. No.: US 2005/0114808 A1
(43) Pub. Date: May 26, 2005

(54) Framework for accurate design rule checking

(76) Inventor: John G. McBride, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/720,565

(22) Filed: Nov. 24, 2003

(51) Int. Cl. G06F 9/45

(52) U.S. Cl. 716/5

(57) ABSTRACT

In an embodiment, a method for accurate design rule evaluation includes constructing sample design portions in a simulator, sweeping simulated design parameters independently, generating a hypermatrix of results of the sweeping, and storing the hypermatrix in memory.

### FIELD OF THE INVENTION

The invention relates to design checking computer software and particularly to a framework for accurate design rule checking.

### DESCRIPTION OF RELATED ART

One way to check the performance of individual elements of a design is to dynamically simulate the design or the relevant elements in each environment in which it must operate. Another way to check the operation of individual parts is to calculate ratios or simple formulas based on a few parameters of the part being analyzed. In VLSI, these ratios may for example be capacitance, FET sizes, or some simple combinations of these.

### BRIEF SUMMARY OF THE INVENTION

In accordance with an embodiment, a method for accurate design rule evaluation is provided. The method includes constructing sample design portions in a simulator, sweeping simulated design parameters independently, generating a hypermatrix of results of the sweeping, and storing the hypermatrix in memory.

In accordance with another embodiment, a system for accurate design rule checking is provided. The system includes means for constructing sample design portions in a simulator, means for sweeping simulated design parameters independently, and means for generating a hypermatrix of results of the sweeping.

### BRIEF DESCRIPTION OF THE DRAWINGS

FIG. 1A is a schematic diagram illustrating an embodiment of the invention;

FIG. 1B is a schematic diagram depicting a sample circuit portion, in accordance with an alternative embodiment of the invention;

FIG. 2 is a depiction of a hypermatrix; and

FIG. 3 is a flow diagram depicting a method in accordance with an embodiment.

### DETAILED DESCRIPTION OF THE INVENTION

In engineering, there is a need for computer software that checks designs to determine if the designs meet certain quality requirements. In Very Large Scale Integrated (“VLSI”) technology, for example, the settings for individual latches need to be checked under nominal conditions, as well as under voltage, temperature, and frequency extremes.

One way to check the performance of individual elements of a design is to dynamically simulate the entire design or the relevant elements of the design in each environment in which the design must operate. Although this tends to provide the most accurate results, simulations are time consuming for large or complex designs. In VLSI circuit design, a widely used open source language for simulation software programs is known as “SPICE.”

Another way to check the operation of individual parts is to calculate ratios or simple formulas based on a few parameters of the part being analyzed. In VLSI, these ratios may for example be capacitance, field effect transistor (“FET”) sizes, or some simple combinations of these. Due to the complexity of many of these checks, the simple formulas typically do not yield the required accuracy. In order to yield the required accuracy of the check, the formulas and the parameters of the formulas become intractable to derive. For example, to set a VLSI latch requires information about the sizes (gate widths) of the FETs driving the latch, the size of the passFETs, the width of the clock pulse enabling the passFETs, the capacitances of the latch input and the latch node, and the size of the feedback FETs holding the charge on the latch node. These are typically too many parameters to model using a hand-derived formula.

In accordance with one embodiment of the invention, a method for accurately and quickly checking a design for quality requirements is provided. To achieve required accuracy and performance, all of the operating conditions to be checked are simulated ahead of time. In a latch-setting example, a sample latch is constructed in a simulator. Each of the required parameters is swept independently to generate a hypermatrix or lookup table of simulated performance results. These hypermatrices need be generated only once or very infrequently. During the checking of an individual design, the parameters swept to generate the hypermatrix are extracted by design checking software. In the parameter extraction process, the design is analyzed to find parasitics (for example capacitance, resistance, inductance) and other characteristics of the design, including FET gate widths and lengths. These parameter values are then supplied as indices, i.e., addresses, to the hypermatrix to look up the result, which is used to judge whether the circuit is designed to perform properly.

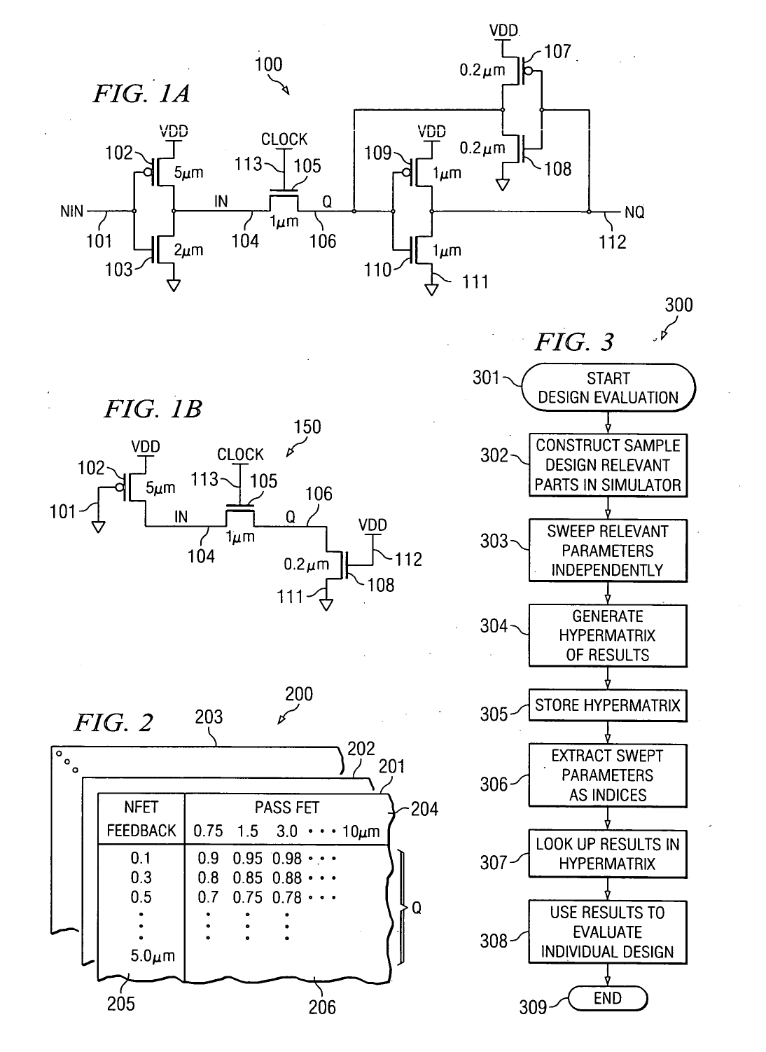

FIG. 1A is a schematic diagram illustrating example VLSI circuit design 100 containing clock input 101 interconnected with PFET driver 102 and feedback NFET 103, driving input signal “in” through connector 104 to passFET 105. Control clock signal 113 supplied to the gate of passFET 105 drives a logic signal Q into latch node 106. Latch node 106 is interconnected to the input of a latch circuit containing feedback FETs 107, 108 and forward driver FETs 109, 110. The output of the latch circuit is connected to inverse latch node 112, which stores logic signal NQ opposite to logic signal Q. Forward driver FET 110 and feedback FETs 103, 108 are connected to ground terminals 111. FET sizes shown in FIG. 1A are gate widths in micrometer (μm) units. The other gate dimensions are fixed by VLSI processing parameters.

FIG. 1B is a schematic diagram depicting sample circuit portion 150 of VLSI circuit design 100. If, for example, it is desired in VLSI circuit design 100 to determine if driver FET driving input signal through connector 104 can set a logic “1” into latch node 106 and “0” into inverse latch node 112, a latch sample circuit portion, for example circuit portion 150 for setting a “1” in latch node 106, can be simulated, as depicted in FIG. 1B.

FIG. 2 is a depiction of hypermatrix 200 pregenerated by sweeping the gate width parameters associated with PFET driver 102, passFET 105, and NFET feedback 108, and tabulating the value of Q in volts for each value of the parameters, in accordance with the embodiments. In the example, the gate width of PFET driver 102 is swept from 0.5 μm to 30 μm, the gate width of passFET 105 is swept from 0.75 μm to 10 μm, and the gate width of NFET feedback 108 is swept from 0.1 μm to 5.0 μm. For ease of understanding, each value for PFET driver 102 is shown as one of a series of planes 201-203 parallel to the plane of the figure. Values 204, 205 for passFET 105 and NFET feedback 108 respectively are shown along horizontal x and vertical y axes respectively in each of PFET driver planes 201-203. Values for Q in volts are tabulated in a two-dimensional array 206 with columns and rows associated with values 204, 205 for passFET 105 and NFET feedback 108 respectively in each plane 201-203 representing a value for PFET driver 102. Alternatively, other well-known mathematical representations can be used to store and access functions of three independent variables. Additionally, more complex representations can be used for functions of four or more independent variables. To find the voltage value Q for individual sample circuit 150, the parameters are used as indices to look up the closest tabulated values of Q, which can then be interpolated to derive the best-fit voltage value for Q.

FIG. 3 is a flow diagram depicting method 300 of accurate design rule evaluation. The design evaluation process starts at operation 301. At operation 302, sample design relevant elements are constructed in a simulator, and at operation 303, relevant design parameters are swept independently. At operation 304, a hypermatrix of results is pregenerated, and is stored in memory at operation 305. At operation 306, the swept parameters are extracted as indices, which are used at operation 307 to look up the results in the pregenerated hypermatrix. At operation 308, the results are used to evaluate an individual design. Optionally, the evaluation process ends at operation 309, or alternatively continues with other operations.

In one embodiment, hypermatrices are, for example, generated for resolving FET contentions, charging and discharging capacitors and storage nodes, propagating noise, and finding trip points and noise margins of static gates. With these hypermatrices, i.e., multi-dimensional lookup tables, implementations of the present embodiments can check large and complex VLSI designs quickly and accurately.

Other embodiments may include, for example, applications of method 300 to civil engineering or mechanical engineering design. Simulations can, for example, be run on various structural beam widths, lengths, heights, structural types, and/or materials, by sweeping these parameters in the simulations, generating hypermatrices, and then applying the hypermatrices to real designs. Important parameters, for example structural beam widths, can then be extracted from the design and used as indices to retrieve the pregenerated results in the hypermatrices, in similar fashion as in VLSI applications. The retrieved results may then be used to evaluate the real designs.

1. A method for accurate design rule evaluation, said method comprising:
constructing sample design portions in a simulator;
sweeping simulated design parameters independently;
generating a hypermatrix of results of said sweeping; and
storing said hypermatrix in memory.

2. The method of claim 1 wherein said design parameters are selected from structural beam widths, beam lengths, beam heights, structural types, materials, FET gate widths, FET gate lengths, capacitance, resistance, and inductance.

3. The method of claim 1 further comprising:
extracting said swept parameters as indices; and
retrieving said results from said pregenerated hypermatrix.

4. The method of claim 3 wherein said retrieving comprises looking up said results in said hypermatrix using said indices.

5. The method of claim 3 further comprising using said results to evaluate an individual design.

6. The method of claim 5 wherein said individual design is selected from VLSI design, electronic circuit design, civil engineering design, and mechanical engineering design.

7. The method of claim 1 wherein said hypermatrix of results is a mathematical representation relating an array of mathematical functions of multiple independent variables to arrays of said multiple independent variables.

8. The method of claim 1 wherein said method is performed using computer executable software code.

9. A system for accurate design rule checking, said system comprising:
means for constructing sample design portions in a simulator;
means for sweeping simulated design parameters independently; and
means for generating a hypermatrix of results of said sweeping.

10. The system of claim 9 further comprising:
means for retrieving said results from said generated hypermatrix.

11. The system of claim 10 further comprising:
means for using said results to evaluate an individual design.

12. The system of claim 10 further comprising:
means for extracting said swept parameters as indices.
